(19) United States
(12) Patent Application Publication
(10) Pub. No.: US 2023/0341711 A1
(43) Pub. Date: Oct. 26, 2023

(54) VARIABLE TRANSMISSION OPTICAL DEVICE AND ANTENNA

(71) Applicant: ALPHAMICRON iNCORPORATED, Kent, OH (US)

(72) Inventor: Bahman TAHERI, Shaker Heights, OH (US)

(73) Assignee: ALPHAMICRON iNCORPORATED, KENT, OH (US)

(21) Appl. No.: 18/138,133

(22) Filed: Apr. 24, 2023

Related U.S. Application Data
(60) Provisional application No. 63/363,404, filed on Apr. 22, 2022.

(51) Int. Cl. G02C 7/10; H01Q 1/27; H04B 10/11; G02F 1/133; G02F 1/1343

(52) U.S. Cl. CPC G02C 7/101; H01Q 1/273; H04B 10/11; G02F 1/13306; G02F 1/13439; H01Q 7/00

(57) ABSTRACT

An eyewear system includes a variable transmission optical device and an antenna. The variable transmission optical device includes a first transparent electrode provided over a first transparent electrode area of a first substrate, a second transparent electrode provided over a second transparent electrode area of a second substrate, and an electro-optic material provided between the substrates, wherein each transparent electrode is interposed between its respective substrate and the electro-optic material. An antenna electrode is provided over an antenna area of the first substrate, wherein the antenna electrode is electrically isolated from the first transparent electrode.

### CROSS-REFERENCE TO RELATED APPLICATIONS

This application claims priority to, and any other benefit of, U.S. Provisional Patent Application Ser. No. 63/363,404 entitled VARIABLE TRANSMISSION OPTICAL DEVICE AND ANTENNA, filed Apr. 22, 2022, the entire disclosure of which is fully incorporated herein by reference.

### TECHNICAL FIELD

The present disclosure relates to systems, for example eyewear systems, that include a variable transmission optical device and an antenna for sending or receiving wireless data.

### BACKGROUND

Eyewear systems have begun to incorporate various electronic capabilities. Various eyewear systems are known that include the ability to take photos, record videos, play audio, act as a phone headset, or display additional information in a person's visual field of view (augmented reality or AR) or the like. Eyewear capable of one or more of such functions are sometimes referred to as “smart glasses”. In many cases, smart glasses use a wireless transmitter/receiver to communicate with other devices, e.g., to download or upload data to a cell phone. Eyewear systems are also known that include electronically controlled lenses that adjust the brightness of light reaching a person's eyes, which may sometimes be referred to as light adaptive eyewear or electronic sunglasses.

It would be advantageous to combine the function of smart glasses with that of light adaptive eyewear. However, such multifaceted functionality generally calls for multiple, often dedicated, components that can add weight, bulk, and complexity to the device. In some cases, this may make the eyewear system uncomfortable or unattractive. Further, there is the risk that one component may interfere with the function of another component. Thus, there is a desire to provide smart glasses with light adaptive functionality without significant sacrifice of comfort, style, or functionality.

### SUMMARY

In accordance with an embodiment, an eyewear system includes a variable transmission optical device (“VTOD”) and an antenna. The variable transmission optical device includes a first transparent electrode provided over a first transparent electrode area of a first substrate, a second transparent electrode provided over a second transparent electrode area of a second substrate, and an electro-optic material provided between the substrates, wherein each transparent electrode is interposed between its respective substrate and the electro-optic material. An antenna electrode is provided over an antenna area of the first substrate, wherein the antenna electrode is electrically isolated from the first transparent electrode.

In accordance with another embodiment, an eyewear system includes a variable transmission optical device (“VTOD”) and an electronic driving subsystem. The VTOD includes a first transparent electrode provided over a first substrate, a second transparent electrode provided over a second substrate, and an electro-optic material comprising a liquid crystal provided between the substrates. Each transparent electrode is interposed between its respective substrate and the electro-optic material. The electronic driving subsystem in electrical communication with the first and second transparent electrodes. The driving subsystem is configured to apply a first voltage profile across the transparent electrodes for controlling an amount of light transmitted through the VTOD, and to apply or sense a second voltage profile to cause one or both of the transparent electrodes to transmit or receive wireless signals. The electronic driving subsystem applies or senses the second voltage profile concurrently with application of the first voltage profile.

Also contemplated herein are methods of operating an eyewear system comprising a VTOD having first and second transparent electrodes and an electro-optic material disposed therebetween, the method includes applying a first voltage profile across the transparent electrodes for controlling an amount of light transmitted through the VTOD; and applying or sensing a second voltage profile on one or both transparent electrodes for transmitting or receiving wireless signals.

### BRIEF DESCRIPTION OF DRAWINGS

FIG. 1 is a schematic cross-section of a non-limiting example of a VTOD according to some embodiments.

FIG. 2 is a perspective view of a non-limiting example of an eyewear system according to some embodiments.

FIG. 3A is a perspective view of a non-limiting example of an eyewear system according to some embodiments.

FIG. 3B is a perspective view of a non-limiting example of an eyewear system according to some embodiments.

FIG. 4A shows a top view of a non-limiting example of a transparent conductor patterned. over a VTOD substrate according to some embodiments.

FIG. 4B is a cross-sectional from FIG. 4A along outline B-B.

FIG. 4C is a cross-sectional view of a non-limiting example of a VTOD according to some embodiments.

FIG. 4D shows a top view of a non-limiting example of a transparent conductor patterned over a VTOD substrate according to some embodiments.

FIG. 5 is a diagram illustrating a non-limiting example of an electronic driving subsystem and VTOD according to some embodiments.

FIG. 6 is a non-limiting example of a VTOD cell time response curve according to some embodiments.

FIG. 7A is a diagram of a VTOD voltage profile at first transparent electrode according to some embodiments.

FIG. 7B is a diagram of the same VTOD voltage profile from FIG. 7A, but also carrying a wireless voltage profile (combined voltage profile) according to some embodiments.

### DETAILED DESCRIPTION

### General VTOD

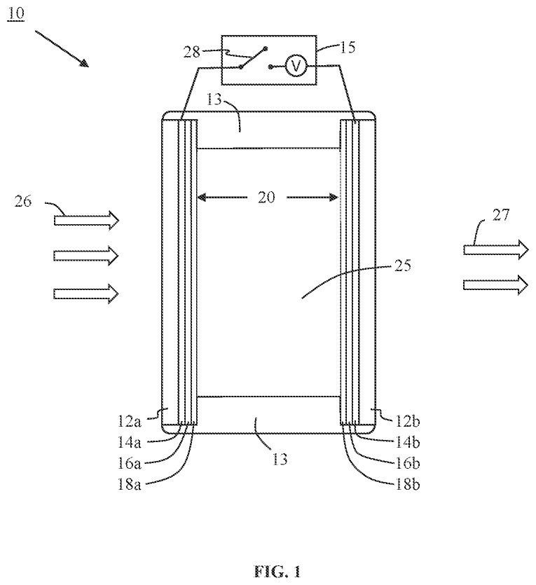

Adaptive eyewear may include one or more variable transmission optical devices (“VTODs”), for example as part of an eyewear system lens element. FIG. 1 is a schematic cross-section of a non-limiting example of a VTOD according to some embodiments, VTOD 10 can controllably act on incident light 26 so that transmitted light 27 has been modulated or altered in some way (brightness, hue, polarization, direction, or the like). VTOD 10 may include a pair of VTOD substrates, 12a, 12b, which may be independently selected and include, for example, a polymeric material, a glass, or a ceramic. VTOD 10 may include a pair of transparent electrically conducting layers, 14a, 14b, which may be provided or coated over each respective substrate surface interior to the cell. The transparent conducting layers may be referred to as first transparent electrode 14a and second transparent electrode 14b. In some embodiments, an optional passivation layer (which in some cases may be referred to as an insulating layer or “hard coat”), 16a, 16b, may be provided over the respective transparent conducting layer. The passivation layer may include, for example, a non-conductive oxide, sol-gel, polymer, or a composite. An optional alignment layer 18a, 18b, may be provided over the passivation layer or the transparent conducting layer. As a non-limiting example, the alignment layer may include polyimide. In some embodiments, the alignment layer may function as a passivation layer. In some embodiments, the alignment layer may be brushed as is known in the art to assist in orienting the electro-optic material, e.g., a liquid crystal “LC” materials, near the surface. In some embodiments, both alignment layers of a cell are brushed. In some embodiments, a cell may include only one brushed alignment layer.

In some embodiments, VTOD 10 includes electro-optic material 25, e.g., a liquid crystal material such as a guest-host mixture or the like, provided between the cell's pair of substrates 12a, 12b. The electro-optic material is capable of changing from a state of higher light transmittance to a state of lower light transmittance in a desired wavelength region of light upon a change in an electric field applied across the electro-optical material. The electric field may be changed, for example, by changing the voltage applied between the VTOD's pair of transparent electrodes 14a, 14b. The substrates and any overlying layers define a cell gap 20. To aid in maintaining the separation, optional spacers (not shown), such as glass or plastic rods or beads, may be inserted between the substrates. The cell gap (normally about 3 to 50 μm, preferably 4-12 μm). The VTOD cell may be enclosed by sealing material 13 such as a UV-cured optical adhesive or other sealants known in the art. In some embodiments, the sealing material may cover a portion of the transparent conducting layers at the substrate edge to contain the electro-optic material.

The transparent electrodes 14a, 14b, may be electrically connected to a controller 15. Controller 15 may include one or more variable voltage supplies which are represented schematically by the encircled V. FIG. 1 shows the VTOD power circuit with its switch 28 open so that no voltage is applied. When switch 28 is closed, a variable voltage or electric field may be applied across liquid crystal guest-host mixture 25. In some embodiments, the voltage applied between the transparent conductive layers may be constant for a period of time with respect to polarity or amplitude. In some embodiments, the voltage profile may change or alternate at some frequency where, for a period of tune, the polarity applied at first transparent electrode 14a is positive and the polarity applied at transparent electrode 14b is negative, and for another period of time, the polarities are reversed where the polarity applied at conductive layer 14a is negative and the polarity applied at conductive layer 14b is positive. This alternating polarity may take on any type of wave form (sinusoidal, square, triangular, sawtooth, or the like) and may generally have a frequency of less than 500 Hz. In some embodiments, the voltage applied between the electrodes may be in a range of 0 to 30 V. In some embodiments, an eyewear system may include a lens element having two or more stacked VTODs as disclosed in PCT Application No. PCT/US22/44310, Titled “MULTI-COLOR VARIABLE TRANSMISSION OPTICAL DEVICE (Soto et al.), the entire contents of which are incorporated herein by reference for all purposes. In some embodiments, an eyewear system may include passive optical features such as lenses, polarizers, photochromic dyes, or the like, that do not generally respond to electronic control.

### Electro-Optic Material

An electro-optic material is one capable of changing its light absorption profile upon application of an electric field. Electro-optical systems include electrochromic and liquid crystal (LC) systems. In some embodiments, the electro-optic material includes a guest-host system having an LC host and a dichroic (DC) dye dissolved or dispersed therein.

A guest-host effect is an electro-optical effect that involves a mixture of dichroic dye “guest” and liquid crystal “host” wherein the dichroism is adjusted within a voltage-controllable liquid crystal cell. In an isotropic host, the molecules are randomly oriented, and the effective absorption is a weighted average: α_{eff}=(2α⊥+α∥)/3. In an anisotropic LC host material, designed for polarization independent operation, the absorption can be increased to α_{eff}=(α⊥+α∥)/2 or decreased (e.g. to α⊥), depending on the desired effect.

In some embodiments, a liquid crystal guest-host includes a mixture of a cholesteric liquid crystal host and a dyestuff material. The dyestuff material may be characterized as having dichroic properties, and as described below, may include a single dye or a mixture of dyes to provide these properties. In some embodiments, the liquid crystal guest-host mixture may be formulated as a “narrow band mixture” (e.g., resulting in a spectral absorption band width having a Full Width at Half Max (FWHM) that is less than or equal to 175 nm) or as a “wide band mixture” (e.g., resulting in spectral absorption band width that is greater than 175 nm).

### LC Host

In general, the LC host may have a negative dielectric anisotropy (“negative LC”) or a positive dielectric anisotropy (“positive LC”). In some embodiments, the host includes a chiral nematic or cholesteric liquid crystal material (collectively “CLC”). The CLC can also be positive or negative, depending on the application. In some embodiments of the CLC, the liquid crystal material is cholesteric, or it includes a nematic liquid crystal in combination with a chiral dopant. A CLC material has a twisted or helical structure. The periodicity of the twist is referred to as its “pitch”. The orientation or order of the liquid crystal host may be changed upon application of an electric field, and in combination with the dyestuff material, may be used to control or partially control the optical properties of the cell. In some embodiments, the CLC may be further characterized by its chirality, i.e.,, right-handed chirality or left-handed chirality.

A wide variety of LC, including CLC, materials are available and have potential utility in various embodiments of the present disclosure.

### Dyestuff Material

To provide dichroic properties, the dyestuff material generally includes at least one dichroic (DC) dye or mixture of DC dyes. In some cases, the dyestuff material may optionally further include a photochromic (PC) dye or a photochromic-dichroic (PCDC) dye whose light absorbance may be activated by exposure to UV light such as sunlight. In some embodiments, the dyestuff material may further include a. small amount of a conventional absorbing dye, e.g., to provide the device with a desired overall hue in the clear state.

### DC Dyes

Dichroic (DC) dyes typically have an elongated molecular shape and exhibit anisotropy in its light absorption properties parallel (α_{∥}) and perpendicular (α_{⊥}) to the molecule, this being characterized by the dichroic ratio, DR=α_{∥}/α_{⊥}. Any molecule having a dichroic ratio (DR) that deviates from unity is one that exhibits “dichroism”. Commonly, the absorption is higher along the long axis of the molecule and such dyes may be referred to as “positive dyes” or dyes exhibiting positive dichroism. Positive DC dyes are generally used herein. However, in some cases, negative DC dyes that exhibit negative dichroism may be used instead. In some embodiments, a DC dye (as measured in a LC host) may have a dichroic ratio of at least 5.0, alternatively at least 6, 7, 8, 9, 10, 11, 12, 13, 14, 15, 16, 17, 18, 19 or 20.

The level of visible light absorption by the DC dye may be a function of the dye type and the LC host. The apparent absorption of visible light may also be a function of voltage. The orientation or long-range order of the LC may be a function of electric field or voltage across the cell thickness. A DC dye exhibits some alignment with the LC host so that application of a voltage may be used to alter the apparent darkness (absorbance) or transparency (opaque-ness) of the cell.

In some embodiments, a DC dye may include a small molecule type of material. In some embodiments, a DC dye may include an oligomeric or polymeric material. The chemical moiety responsible for light absorption may, for example, be a pendant group on a main chain. Multiple DC dyes may optionally be used, for example, to tune the light absorption envelope or to improve overall cell performance with respect to lifetime or some other property. DC dyes may include functional groups that may improve solubility, miscibility with or bonding to the LC host. Some non-limiting examples of DC dyes may include azo dyes, for example, azo dyes having 2 to 10 azo groups, or alternatively, 2 to 6 azo groups. Other DC dyes are known in the art, such as anthraquinone and perylene dyes. Generally, molecule with dichroic properties are know, such as for example those described in “Dyes as guests in ordered systems: current understanding and future directions” By Mark T. Sims (Pages 2363-2374) in Liquid Crystals, Volume 43, 2016—Issue 13-15.

### Other VTOD Cell Features

### Substrate

Referring again to FIG. 1, in some embodiments, the VTOD substrate 12a, 12b may be independently selected and may include a plastic, a glass, a ceramic, or some other material. Choice of material and its particular properties depends in part on the intended application. For many applications, the substrate should be at least partially transmissive to visible light. In some embodiments a substrate may have higher than 45% transmission to visible radiation having a wavelength between 400 nm and 700 nm, alternatively, higher than 50%, 60%, 70%, 80%, 90%, or 95% transmission. In some embodiments, the substrate may have high optical clarity (low haze) so that a person may clearly see through the VTOD. In some embodiments, the support may optionally have some color or tint. In some embodiments, the substrate may have an optical coating on the outside of the cell. A substrate may be flexible or rigid.

As some non-limiting examples, a plastic substrate may include a polycarbonate (PC), a polycarbonate and copolymer blend, a polyethersulfone (PES), a polyethylene terephthalate (PET), cellulose triacetate (TAC), a polyamide, p-nitrophenylbutyrate (PNB), a polyetheretherketone (PEEK), a polyethylenenapthalate (PEN), a polyetherimide (PEI), polyarylate (PAR), a polyvinyl acetate, a cyclic olefin polymer (COP) or other similar plastics known in the art. In some non-limiting examples, flexible glass including materials such as Corning® Willow® Glass and the like can be used as a substrate. A substrate may include multiple materials or have a multi-layer structure.

In some embodiments, the thickness of a substrate may be in a range of 25 μm to 500 μm. Preferred range includes 50 μm-200 μm.

### Transparent Conducting Layer

“Visible light” generally refers to a wavelength range of about 400 nm to about 700 nm. By “transparent” conducting layer, it is meant that the conducting layer allows an overall transmittance of at least 45% of incident visible light. A transparent conducting layer may absorb or reflect a portion of visible light and still be useful. In some embodiments, the transparent conducting layer may include a transparent conducting oxide (TCO) including, but not limited to, ITO or AZO. In some embodiments, the transparent conducting layer may include a conductive polymer including, but not limited to, PEDOT:PSS, a poly(pyrrole), a polyaniline, a polyphenylene, or a poly(acetylene). In some embodiments, the transparent conducting layer may include a partially transparent thin layer of metal or metal nanowires, e.g., formed of silver, copper, aluminum, or gold. In some embodiments, the transparent conducting layer may include graphene.

### Eyewear System

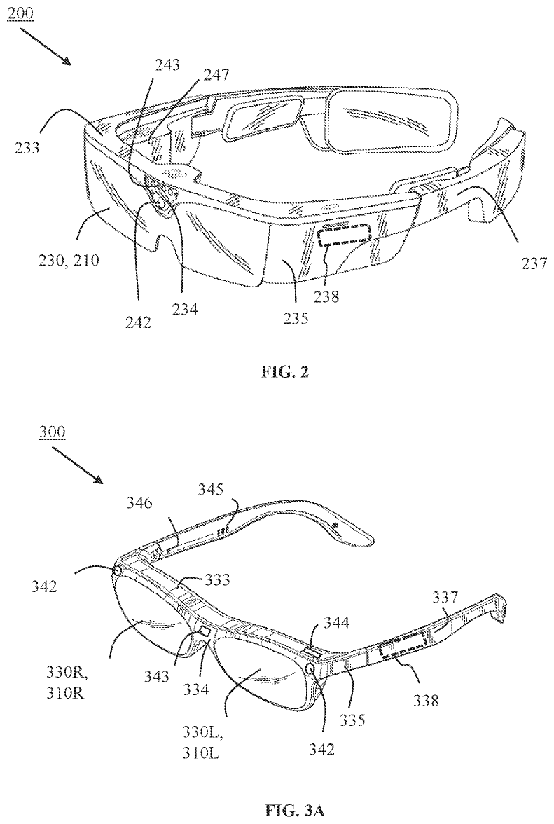

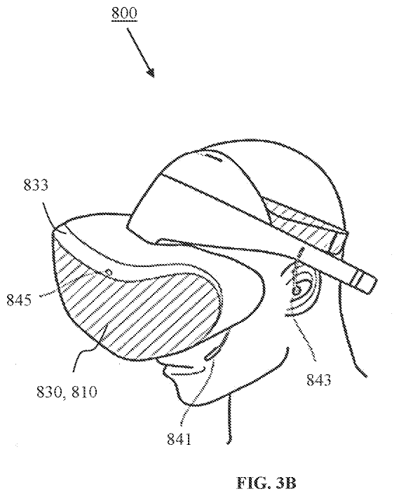

FIGS. 2 and 3A are perspective views of some non-limiting examples of eyewear systems according to some embodiments. In some cases, as shown in FIG. 2, an eyewear system 200 may include a single lens element 230 extending across both eyes of a person. The lens element may include a VTOD 210. In some embodiments, as shown in FIG. 3A, an eyewear system 300 may include separate lens elements 330L and 330R. One or both lens elements may include a VTOD, e.g., VTOD 310L and/or VTOD 310R. The structure and materials of the VTODs may be the same or different, and the operation of the VTODs may be commonly controlled in full or in part, or individually controlled in full or in part. In some cases, a VTOD (e.g., 210, 310L, 310R) may be combined with, or laminated to, another optical element or carrier such as a prescription or non-prescription lens to form the respective lens element.

The optical elements or VTODs may be attached to an eyewear system frame, which can have many shapes. An eyewear system frame may include a primary frame (which may in some cases may be referred to as a “rim”) 233, 333 to which the VTOD may be attached. An eyewear system frame may optionally further include a bridge region 234, 334, end pieces 235, 335 attached to (or forming part of) the primary frame or rim, and/or temples 237, 337 extending from the end pieces which may have ends or tips that fit behind a person's ears. In some cases, a VTOD may be attached to a frame component in addition to, or other than, the primary frame, e.g., to an end piece or temple. In some embodiments, a VTOD may act as a side eye shield, for example, where the VTOD extends partly along one or both temples. Various frames and eyewear system shapes can be used, such as a VR system 800 as shown in FIG. 3B which includes primary frame 833, lens element 830 and VTOD 810. The VR system may include other electronic devices such as a microphone 841, an earpiece 843, a light sensor 845, or numerous other devices.

In some embodiments, the eyewear system is a smart eyewear system having various electronic components besides the VTOD. For example, the eyewear system may include one or more cameras 242, 342, sensors 243, 343, speakers 345, microphones 346, operational switches 344, display projection devices 247 for augmented reality, or some other useful electronic component. The locations of the various electronic devices are not limited to the locations shown in the figures. The eyewear system may include onboard electronics or controllers for operating such electronic devices. In some cases, onboard electronics 238, 338 may be embedded within the eyewear system. The onboard electronics may be separate from or integrated with the controller(s) that operate the VTODs. The eyewear system may further include one or more batteries (optionally rechargeable) or a power cable leading to a separate battery pack. The temple, end piece, or frame may include touch-sensitive features, e.g., surface or projected capacitive technology, that allows touch control via finger taps, sweeps or the like. In some cases, the eyewear system may include components (hardware, software, and/or firmware) that allow operation by voice command.

The eyewear system may include wireless electronics for transmitting and/or receiving wireless signals, e.g., via a transceiver or the like. In some embodiments, the eyewear system may be in wireless communication with a cell phone or other electronic device. For example, the cell phone may include one or more apps that control the eyewear system in some way (e.g., play music, operate microphones/speakers for phone calls, display images via AR, or the like). In some cases, the cell phone may receive data from the eyewear system, e.g., videos, images, voice recordings, GPS location history, or the like. In some cases, such apps may also enable operational communication between the VTOD and the cell phone (or other device).

In some cases, the wireless signals for communication between the eyewear system and another device may use WIFI frequencies, e.g., those above about 800 MHz and may extend as high as about 70 GHz. In some embodiments, the WIFI communication may utilize Bluetooth technology and frequencies.

Effective wireless communication generally requires one or more antennae. For conventional smart glasses, these are typically built into or onto the frame by adding wires. For example, a wire may be provided in the rim around each lens, across the bridge, or along the temples. In some cases, an antenna system may be used including multiple antennas in various locations and orientations that may widen the directional area to/from which it effectively sends/receives signals.

In embodiments of the present. disclosure, the antenna or antenna. system may be simplified by leveraging components of the VTOD, in particular one or both transparent electrodes.

### Patterned Transparent Conductor

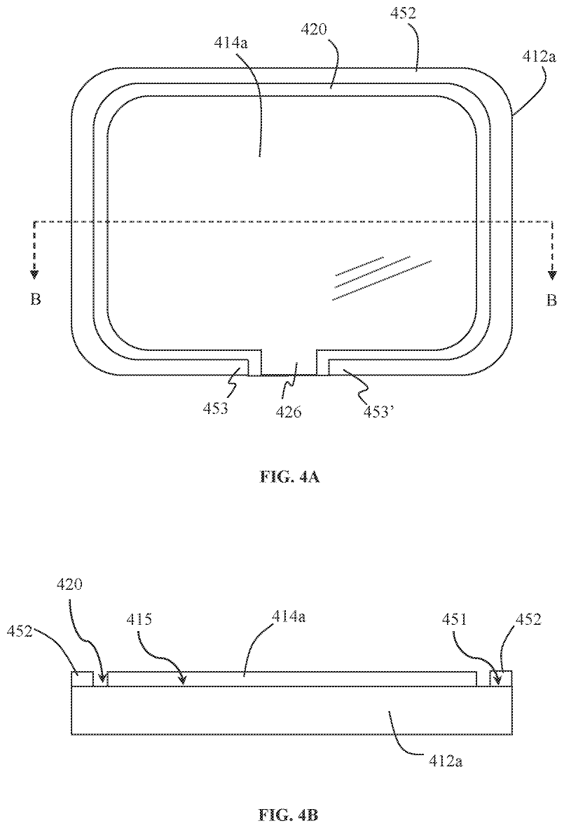

In some embodiments, one or both transparent conductive layers of a VTOD may be patterned so that a portion of it may be used as an antenna electrode instead of as a VTOD electrode. For example, FIG. 4A shows a top view of a non-limiting example of a transparent conductor patterned over a VTOD substrate according to some embodiments. The shape may in some cases correspond to a desired lens element for an eyewear system. FIG. 4B is a cross-sectional from FIG. 4A along outline B-B. In some embodiments a transparent conductive layer may be applied across first VTOD substrate 412a and then patterned by conventional lithographic methods to etch away a portion thereby forming a first transparent electrode 414a provided over a first electrode area 415 of the substrate, and an antenna electrode 452 provided over an antenna area 451 of the first substrate and electrically isolated from the first transparent electrode 414a. In some embodiments, the patterning may form a first transparent electrode contact region 426 for connecting the first transparent electrode to driving circuitry for the VTOD. Contact to the antenna electrode for connecting to antenna circuitry (e.g., a receiver, transmitter, a transceiver) may be anywhere along the antenna, but may optionally be at antenna electrode contact area 453 or 453′ or both. The antenna electrode may in some embodiments act as a loop antenna, but other designs may be used to make, for example, a dipole antenna, a hybrid of both, or some other antenna type. In some embodiments, first VTOD substrate 412a (having the antenna electrode) may represent the substrate and electrode furthest from a user's eye(s).

Many methods can be used for forming the first transparent electrode 414a and antenna electrode 452. In some embodiments, rather than etch-patterning a transparent conductor by lithography, the first transparent electrode 414a and antenna electrode 452 may be formed by printing an etchant or a conductivity-damaging agent in the desired isolation (non-conductive) region 420 between these features. In some embodiments, the first transparent electrode and antenna electrode may be formed directly by pattern printing using a transparent conductive ink, such printing including but not limited to, ink jet, flexographic, gravure, or contact printing. In some embodiments, the material of the first transparent electrode may be the same as the material of the antenna electrode. In some embodiments, the material of the first transparent electrode may be different from the material of the antenna electrode. As illustrated in FIG. 4B, in some embodiments, the antenna electrode 452 and the first transparent electrode 414a may lie in a common plane parallel to a plane defined by the surface of the first VTOD substrate 412a.

FIG. 4C is a cross-sectional view of a non-limiting example of a VTOD according to some embodiments. VTOD 410 may include a pair of VTOD substrates, first VTOD substrate 412a, and second VTOD substrate 412b, which may be independently selected as previously described. VTOD 410 may include a pair of transparent electrically conducting layers, first transparent electrode 414a, and second transparent electrode 414b, which may be provided or coated over each respective substrate surface interior to the cell. An antenna electrode 452 may also be formed on the first VTOD substrate in electrical isolation from the first transparent electrode 414a, e.g., as described with respect to FIGS. 4A and 4B. That is, the first transparent electrode may be provided over a first electrode area of the first substrate, and the antenna electrode may be provided over an antenna area of the first substrate. Similarly, the second transparent electrode may be provided over a second electrode area of the second substrate. In the embodiment shown in FIG. 4C, the second electrode area occupies substantially the entire surface of the second substrate, but other designs may be used. VTOD 410 includes electro-optic material 425 between the transparent electrodes. The VTOD cell may be enclosed by sealing material 413 such as a UV-cured optical adhesive or other sealants known in the art. VTOD 410 may generally have any of the properties, materials, layer structure, or cell architectures described previously with respect to FIG. 1.

In some embodiments, the sealing material 413 may optionally cover a portion of the transparent conducting layers at the edge. In some embodiments, a sealing material may cover at least a portion of the antenna electrode. Such a design makes efficient use of the available substrate area for both sealing and the antenna electrode. That is, the edge area is often wasted space with respect to VTOD functionality due to the need for sealants and the like, but such space is no longer wasted in the present embodiment since it now includes an antenna electrode. The design further ensures that the antenna electrode does not inadvertently act on the electro-optic material or interfere with the VTOD operation. Although not shown in FIG. 4C, the second transparent electrode may optionally be patterned, e.g., to provide for another antenna electrode on the second VTOD substrate. Alternatively, the positions of the first and second transparent electrodes may be switched so that the antenna is on the second substrate. In some embodiments. both substrates can have an antenna electrode used for different purposes.

FIG. 4D shows a top view of another non-limiting example of a transparent conductor patterned over a VTOD substrate according to some embodiments. The shape may in some cases correspond to a desired lens element for an eyewear system. First transparent electrode 460 is separated from antenna electrode 464 by the isolation (non-conductive) region 462. The isolation region 462 may correspond to the surface of a VTOD substrate or a portion of a conductive layer that has been rendered non-conductive. In this embodiment, the antenna electrode does not extend around the entire periphery of the cell but only occupies a portion of the periphery. In some examples, this portion may be positioned where the VTOD connects to the primary frame of the eyewear system.

### Common Transparent Electrode/Antenna Electrode

In some embodiments, there is no need for two conductive areas separated by an isolation area. Rather, one or both transparent electrodes of the VTOD may also act as an antenna electrode for wireless communication. For example, the VTOD may look similar to that shown in FIG. 1 but with modified electronics to allow transmission or reception of wireless signals. In particular, the eyewear system may include an electronic driving subsystem that operates both the VTOD function and the antenna function.

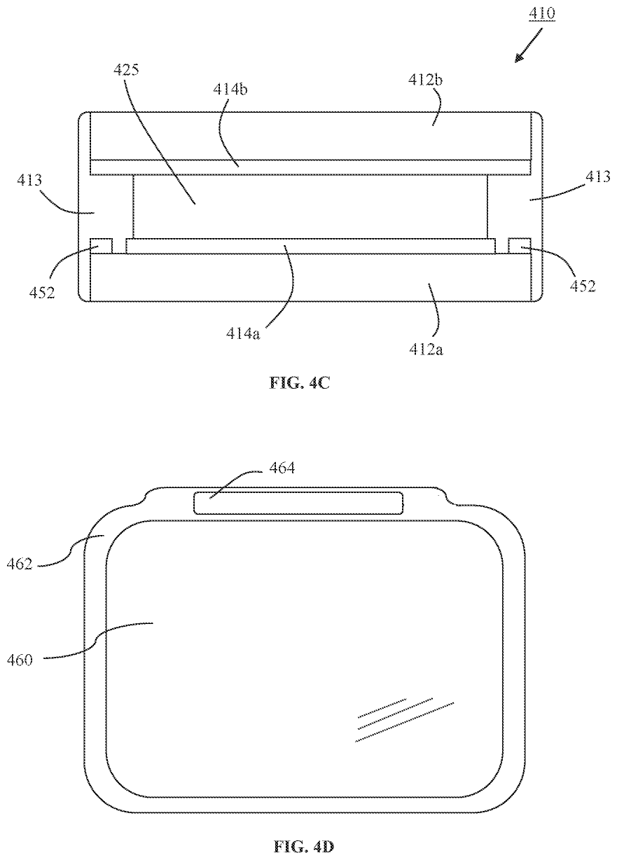

FIG. 5 is a diagram illustrating a non-limiting example of an electronic driving subsystem and VTOD according to some embodiments. For clarity, only a few features of the VTOD are shown in FIG. 5, but the VTOD properties, materials, layer structure and cell structure may be as previously described. VTOD 510 may include a first substrate 512a, a first transparent electrode 514a disposed over a surface of the first substrate interior to the VTOD cell, a second substrate 512b, a second transparent electrode 514b disposed a surface of the second substrate interior to the VTOD cell, and electro-optic material 525 disposed between the two transparent electrodes. The transparent electrodes may be in electrical communication with electronic driving subsystem 560. In some embodiments, the electronic driving subsystem 560 may include a controller 562, a signal modifier 566, and a receiver 568. The first transparent electrode 514a may also serve as an antenna for wireless communications and is connected to the electronic driving subsystem via lead 564a. The second transparent electrode may be connected to the electronic driving subsystem via lead 564b.

Controller 562 may include circuitry for applying the desired VTOD and/or wireless driving signal. A VTOD driving signal is an electric signal that is applied to the transparent electrodes that has various characteristics including voltage (amplitude, polarity), frequency, duration, and waveform (sine wave, square wave, triangle wave, sawtooth wave, alternating polarity, non-alternating polarity, or the like). These characteristics may be referred to as the VTOD voltage profile. Each of these characteristics may influence the LC's molecular movement and orientation, which in turn results in a change of the VTOD's optical response. In some cases, a VTOD may be designed so that the time response of the LC cell to an applied voltage is visually fast, that is, it may change state from a dark (absorptive) or opaque (scattering) state to a more transparent (transmissive) state (or vice versa) almost instantaneously to an observer, or in less than 0.25 sec. Even when imperceptible to an observer, the molecular reorientation across the cell takes some time, which is a function of the LC host material, the LC-dye mixture, temperature, voltage, cell gap and other factors.

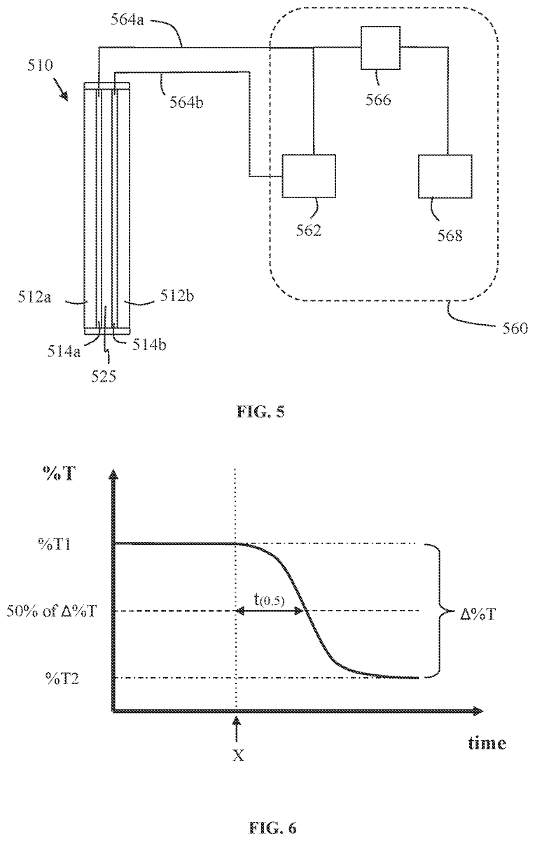

FIG. 6 is a non-limiting example of a VTOD cell time response curve according to some embodiments. At a first voltage V1, a VTOD may have a first optical transmission, % T1. When a second voltage V2 is applied that is sufficient to induce molecular reorientation, the VTOD may have a second optical transmission, % T2, that is less than % T1. The change may be referred to as Δ% T. As shown in FIG. 6, this transition over time may not always be linear. There are many ways to measure a response time. One metric is t_{(0.5)}, which is the time it takes for the % T to change 50% of Δ% T from time X when the voltage is switched from V1 to V2. In some embodiments, VTOD 510 may have a t_{(0.5)} that is not less than 0.1 milliseconds, alternatively not less than 0.5, 1, 2, 5, 10, 20, 50, 100 or 200 milliseconds. Although there is a wide variety of useful VTOD voltage profiles, in general, a VTOD frequency component is generally less than 1 kHz, alternatively less than 500 Hz, 250 Hz, 150 Hz, 100 Hz, 80 Hz, 60 Hz, 50 Hz, or 40 Hz. In some cases, the frequency component may be at least 30 Hz, e.g., to avoid possible perceived flicker by a user. In some embodiments the VTOD voltage profile has no frequency component (0 Hz) or is DC voltage. In some embodiments, the VTOD voltage profile may include alternating positive and negative polarities. In some embodiments, the alternating polarities occur periodically (e.g., at a frequency in a range of about 30 to 250 Hz, alternatively about 60 to 150 Hz) or at select times.

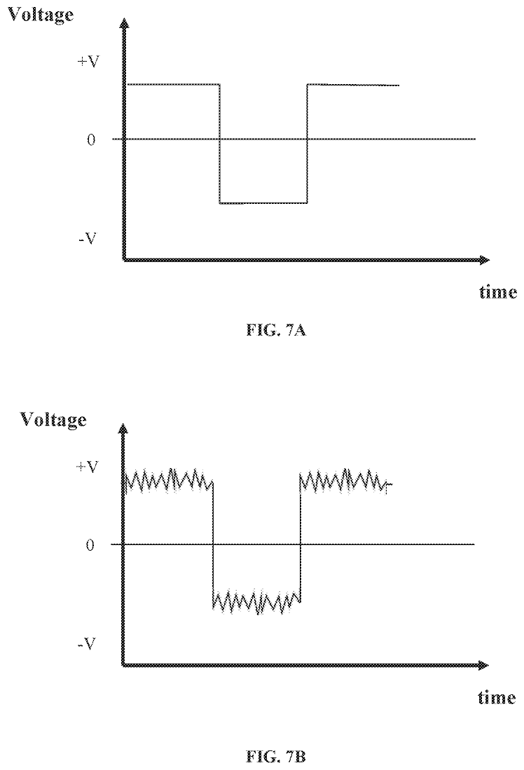

In some embodiments, the. first transparent electrode 514a (FIG. 5) may also act as an antenna electrode for transmitting wireless data when an antenna/wireless voltage is applied. For example, controller 562 may add an RF signal characterized by a wireless voltage profile in addition to or on top of the VTOD voltage profile applied at the first transparent electrode via. lead 564a. In some cases, the antenna or wireless voltage profile may have a frequency of at least 200 MHz, alternatively, at least 400 MHz, 600 MHz, 800 MHz, 1 GHz, 2 GHz, 5 GHz, 10 GHz, 20 GHz, or 50 GHz. The wireless voltage profile may use standard wireless communications frequencies, e.g., as defined by IEEE 802.11. These wireless voltage profile frequencies are too fast to cause any significant effect on the VTOD response, thus allowing the VTOD first transparent electrode to also act as a transmitter antenna electrode. FIG. 7A is a diagram of a VTOD voltage profile at first transparent electrode 514a and FIG. 7B is a diagram of the same VTOD voltage profile also carrying a wireless voltage profile (combined voltage profile). FIGS. 7A and 7B are simply illustrative and the actual wave forms, amplitudes, and frequencies may take on many alternative appearances. Rather than controller 562, a separate RF/wireless signal generating component could be placed in communication with lead 564a to apply the wireless voltage waveform component.

In some embodiments, the first transparent electrode 514a may act as an antenna for receiving wireless data. For example, a controller 562 may apply a VTOD voltage profile such as shown in FIG. 7A. The first transparent electrode 514a may also be in range of another device transmitting wireless signals. These wireless signals cause fluctuations in the voltage profile at the transparent electrode reflective of the frequency of the transmitted signals. That is, the received wireless signals may superimpose a wireless voltage profile onto the VTOD voltage profile such as shown in FIG. 7B. Referring again to FIG. 5, in some embodiments, a signal modifier component 566 may be electronic communication with the first transparent electrode 514a. In some cases, a signal modifier may include a bandpass or other frequency filter that isolates the wireless voltage profile signal. In some embodiments, a signal modifier may be in communication with controller 562 and subtract the applied VTOD voltage to isolate the wireless voltage profile signal. The isolated signal may be fed to receiver 568 for conversion to computer-readable data. The electronic driving subsystem may include additional features or functionality, e.g., amplifiers, modulators, electronic filters, or the like. The electronic driving subsystem may further be in electronic communication with one or more additional antennas optionally provided with other electronic components or elsewhere on the eyewear system.

Still further embodiments herein include the following enumerated embodiments.

1. An eyewear system comprising:
a) a variable transmission optical device (“VTOD”') comprising:
i) a first transparent electrode provided over a first transparent electrode area of a first substrate;
ii) a second transparent electrode provided over a second transparent electrode area of a second substrate; and
iii) an electro-optic material provided between the substrates, wherein each transparent electrode is interposed between its respective substrate and the electro-optic material; and
b) an antenna electrode provided over an antenna area of the first substrate, wherein the antenna electrode is electrically isolated from the first transparent electrode.

2. The eyewear system of embodiment 1, wherein the antenna electrode is not in contact with the electro-optic material.

3. The eyewear system of embodiment 1 or 2, wherein the VTOD further comprises a sealing material to contain said electro-optic material, and wherein the sealing material covers at least a portion of the antenna electrode.

4. The eyewear system according to any of embodiments 1-3, wherein the antenna electrode acts as a loop antenna.

5. The eyewear system according to any of embodiments 1-3, wherein the antenna electrode acts as a dipole antenna.

6. The eyewear system according to any of embodiments 1-5, further comprising an eyewear system frame to which the VTOD is attached.

7. The eyewear system of embodiment 6, further comprising one or more electronic components provided on or in the eyewear system frame, wherein said electronic components comprises a camera, a sensor, a speaker, a microphone, a switch, a display projection device, or any combination thereof.

8. The eyewear system of claim 6 or 7, further comprising a second antenna electrode provided on the eyewear system frame.

9. The eyewear system of embodiment 8, wherein the antenna electrode acts as a loop antenna and the second antenna electrode acts as a dipole antenna.

10. The eyewear system according to any of embodiments 1-9, further comprising wireless electronics for transmitting or receiving wireless signals wherein the antenna electrode is in electronic communication with the wireless electronics.

11. The eyewear system according to any of embodiments 1-10, wherein the first transparent electrode comprises a transparent conducting oxide, a conductive polymer, graphene, metal nanowires, or a thin layer of metal.

12. The eyewear system according to any of embodiments 1-11, wherein the antenna electrode comprises a transparent conducting oxide, a conductive polymer, graphene, metal nanowires, or a thin layer of metal.

13. The eyewear system according to any of embodiments 1-12, wherein the first transparent electrode and the antenna electrode comprise substantially the same conductive material.

14. The eyewear system according to any of embodiments 1-13. wherein the first transparent electrode and the antenna electrode lie in a common plane parallel to a plane defined by a surface of the first substrate.

15. An eyewear system comprising:
a) a variable transmission optical device (“VTOD”) comprising:
i) a first transparent electrode provided over a first substrate
ii) a second transparent electrode provided over a second substrate; and
iii) an electro-optic material provided between the substrates, wherein each transparent electrode is interposed between its respective substrate and the electro-optic material; and
b) an electronic driving subsystem in electrical communication with the first and second transparent electrodes, the driving subsystem configured to:
i) apply a first voltage profile across the transparent electrodes for controlling an amount of light transmitted through the VTOD; and
ii) apply or sense a second voltage profile to cause one or both of the transparent electrodes to transmit or receive wireless signals.

16. The eyewear system of embodiment 15, wherein the first voltage profile has a frequency of 1 kHz or less.

17. The eyewear system of embodiment 15 or 16, wherein the second voltage profile has a frequency of greater than or equal to 200 MHz.

18. The eyewear system according to any of embodiments 15-17, wherein the first voltage profile has a frequency in a range of about 30 to about 200 Hz.

19. The eyewear system according to any of embodiments 15-18, wherein the second voltage profile has a frequency of at least 1 GHz.

20. The eyewear system according to any of embodiments 15-19, wherein the electronic driving subsystem applies or senses the second voltage profile concurrently with application of the first voltage profile.

21. The eyewear system according to any of embodiments 15-20, wherein the second voltage profile is operative to send or receive wireless signals.

22. The eyewear system according to any of embodiments 15-21, wherein at least one transparent electrode functions as an antenna for sending or receiving wireless signals.

23. The eyewear system according any of embodiments 15-22, wherein the electronic driving subsystem comprises i) a controller in electrical communication with the first and second transparent electrodes, ii) a signal modifier component in electrical communication with the controller, and iii) a receiver in electrical communication with the signal modifier.

24. The eyewear system of embodiment 23. wherein the signal modifier component comprises a bandpass filter.

25. The eyewear system of embodiment 23 or 24, wherein the receiver converts electric signals received from the signal modifier into computer-readable data.

26. The eyewear system according to any of embodiments 15-25, further comprising an eyewear system frame to which the VTOD is attached, wherein at least a portion of the electronic driving subsystem is provided as part of the eyewear system frame,

27. The eyewear system according to any of embodiments 15-26, wherein the electro-optic material comprises a liquid crystal,

28. A method of operating an eyewear system comprising a VTOD having first and second transparent electrodes and an electro-optic material disposed therebetween, the method comprising:
applying a first voltage profile across the transparent electrodes for controlling an amount of light transmitted through the VTOD; and
applying or sensing a second voltage profile on one or both transparent electrodes for transmitting or receiving wireless signals.

29. The method of embodiment 28, wherein the first voltage profile has a frequency of 1 kHz or less.

30. The method of embodiment 28 or 29, wherein the second voltage profile has a frequency of greater than or equal to 200 MHz.

31. The method according to any of embodiments 28-30, wherein the first voltage profile has a frequency in a range of about 30 to about 200 Hz.

32. The method according to any of embodiments 28-31, wherein the second voltage profile has a frequency of at least 1 GHz.

33. The method according to any of embodiments 28-32, further comprising applying or sensing the second voltage profile concurrently with applying of the first voltage profile.

34. The method according to any of embodiments 28-33, wherein the electro-optic material comprises a liquid crystal.

35. A method of making an eyewear system, the method comprising:
patterning a first transparent electrode and an antenna electrode over a first substrate, wherein the antenna electrode is electrically isolated from the first transparent electrode; and
assembling a VTOD, the VTOD comprising the first transparent electrode provided over a first transparent electrode area of the first substrate, a second transparent electrode provided over a second transparent electrode area of a second substrate, and an electro-optic material provided between the substrates, wherein each transparent electrode is interposed between its respective substrate and the electro-optic material.

36. The method of embodiment 35, wherein the antenna electrode is not in contact with the electro-optic material.

37. The method of embodiment 35 or 36, further comprising sealing the VTOD with a sealing material thereby containing the electro-optic material, wherein the sealing material covers at least a portion of the antenna electrode.

38. The method according to any of embodiments 35-37, wherein the patterning comprises etching or deactivating a layer of conductive material provided on the first substrate to form the first transparent conductor and antenna electrode.

39. The method according to any of embodiments 35-37, wherein the pattern comprises printing the first transparent conductor from a transparent conductor ink and printing the antenna from an antenna ink.

40. The method of embodiment 39, wherein at least one printing step comprises flexographic printing, gravure printing, or inkjet printing.

41. The method of embodiment 39 or 40, wherein the transparent conductor ink is the same as the antenna ink.

42. The method of embodiment 41, wherein printing the first transparent conductor and printing the antenna electrode are performed in a common printing step.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the layer” includes reference to one or more layers and equivalents thereof known to those skilled in the art, and so forth. The invention has now been described in detail for the purposes of clarity and understanding. However, it will be appreciated that certain changes and modifications may be practiced within the scope of the appended claims.

All publications, patents, and patent applications cited herein are hereby incorporated by reference in their entirety for all purposes. None is admitted to be prior art.

What is claimed is:

1. An eyewear system comprising:
a) a variable transmission optical device (“VTOD”) comprising:
i) a first transparent electrode provided over a first transparent electrode area of a first substrate:
ii) a second transparent electrode provided over a second transparent electrode area of a second substrate; and
iii) an electro-optic material provided between the substrates, wherein each transparent electrode is interposed between its respective substrate and the electro-optic material; and
b) an antenna electrode provided over an antenna area of the first substrate, wherein the antenna electrode is electrically isolated from the first transparent electrode.

2. The eyewear system of claim 1, wherein the antenna electrode is not in contact with the electro-optic material.

3. The eyewear system of claim 1, wherein the VTOD further comprises a sealing material to contain said electro-optic material, and wherein the sealing material covers at least a portion of the antenna electrode.

4. The eyewear system of claim 1, wherein the antenna electrode acts as a loop antenna.

5. The eyewear system of claim 1, wherein the antenna electrode acts as a dipole antenna.

6. The eyewear system of claim 1, further comprising an eyewear system frame to which the VTOD is attached, and one or more electronic components provided on or in the eyewear system frame, wherein said one or more electronic components comprise a camera, a sensor, a speaker, a microphone, a switch, a display projection device, or any combination thereof.

7. The eyewear system of claim 6, further comprising a second antenna electrode provided on the eyewear system frame.

8. The eyewear system of claim 7, wherein the antenna electrode acts as a loop antenna and the second antenna electrode acts as a dipole antenna.

9. The eyewear system of claim 1, further comprising wireless electronics for transmitting or receiving wireless signals wherein the antenna electrode is in electrical communication with the wireless electronics.

10. The eyewear system of claim 1, wherein the first transparent electrode comprises a transparent conducting oxide, a conductive polymer, graphene, metal nanowires, or a thin layer of metal.

11. The eyewear system of claim 1, wherein the antenna electrode comprises a transparent conducting oxide, a conductive polymer, graphene, metal nanowires, or a thin layer of metal.

12. The eyewear system of claim 1, wherein the first transparent electrode and the antenna electrode comprise substantially the same conductive material.

13. The eyewear system of claim 1, wherein the first transparent electrode and the antenna electrode lie in a common plane parallel to a plane defined by a surface of the first substrate.

14. An eyewear system comprising:
a) a variable transmission optical device (“VTOD”) comprising:
i) a first transparent electrode provided over a first substrate;
ii) a second transparent electrode provided over a second substrate; and
iii) an electro-optic material comprising a liquid crystal provided between the substrates, wherein each transparent electrode is interposed between its respective substrate and the electro-optic material; and
b) an electronic driving subsystem in electrical communication with the first and second transparent electrodes, the driving subsystem configured to:
i) apply a first voltage profile across the transparent electrodes for controlling an amount of light transmitted through the VTOD; and
ii) apply or sense a second voltage profile to cause one or both of the transparent electrodes to transmit or receive wireless signals,
wherein the electronic driving subsystem applies or senses the second voltage profile concurrently with application of the first voltage profile.

15. The eyewear system of claim 14, wherein the first voltage profile has a frequency of 1 kHz or less.

16. The eyewear system of claim 14, wherein the second voltage profile has a frequency of greater than or equal to 200 MHz.

17. The eyewear system of claim 14, wherein the first voltage profile has a frequency in a range of about 30 to about 200 Hz.

18. The eyewear system of claim 14, wherein the second voltage profile has a frequency of at least 1 GHz.

19. The eyewear system of claim 14, wherein the second voltage profile is operative to send or receive wireless signals.

20. The eyewear system of claim 14, wherein at least one transparent electrode functions as an antenna for sending or receiving wireless signals.

21. The eyewear system of claim 14, wherein the electronic driving subsystem comprises i) a controller in electrical communication with the first and second transparent electrodes, ii) a signal modifier component in electrical communication with the controller, and iii) a receiver in electrical communication with the signal modifier.

22. The eyewear system of claim 21, wherein the signal modifier component comprises a bandpass filter.

23. The eyewear system of claim 21, wherein the receiver converts electric signals received from the signal modifier into computer-readable data.

24. The eyewear system of claim 14, further comprising an eyewear system frame to which the VTOD is attached, wherein at least a portion of the electronic driving subsystem is provided as part of the eyewear system frame.
